(19) United States
(12) Patent Application Publication
(10) Pub. No.: US 2025/0103902 A1
(43) Pub. Date: Mar. 27, 2025

(54) SYSTEM AND METHOD FOR TRAINING A MACHINE LEARNING MODEL IN A DISTRIBUTED SYSTEM

(71) Applicant: Kabushiki Kaisha Toshiba, Tokyo (JP)

(72) Inventors: Alexander HERZOG, Bristol (GB); Marcello BULLO, Bristol (GB); Pietro Edoardo CARNELLI, Bristol (GB); Aftab KHAN, Bristol (GB)

(73) Assignee: Kabushiki Kaisha Toshiba, Tokyo (JP)

(21) Appl. No.: 18/471,749

(22) Filed: Sep. 21, 2023

(51) Int. Cl. G06N 3/098

(52) U.S. Cl. CPC G06N 3/098

(57) ABSTRACT

A computer-implemented method for training a machine learning model in a distributed system, The distributed system comprises a plurality of nodes that exchange updates to communally train the machine learning model. Each node of the plurality of nodes maintains a local version of the machine learning model. The local version of the machine learning model of each of the plurality of nodes has been initialised with the same one or more respective parameter values. The method comprises a node: receiving an update to a local model from at least one other node in the distributed system, the local model comprising the local version of the machine learning model and the update comprising a dense array of one or more first parameter deltas, the one or more first parameter deltas being ordered in the dense array in an order determined by a reference model, each first parameter delta representing a difference between a parameter of the local model and a corresponding parameter of an updated version of the machine learning model that is maintained by the at least other node; updating the local model based on the received update and the reference model to determine an updated local model; determining one or more second parameter deltas, each second parameter delta representing a difference between a parameter of the updated local model and a corresponding parameter of a previous version of the local model; and sending an update to the at least one other node in the distributed system, wherein the update comprises a dense array of the one or more second parameter deltas, the one or more second parameter deltas being ordered in the dense array in an order determined by the reference model.

### FIELD

The present disclosure relates to methods and systems for training a machine learning model in a distributed system. In particular, but without limitation, this disclosure relates to methods of performing federated learning efficiently by reducing a size of updates shared between devices within the system.

### BACKGROUND

Machine Learning (ML) methods aim to train a model based on observed data. In traditional ML approaches, raw data collected by edge devices (such as within an internet of things, IoT, network) is communicated back to a central server in order to train a global model.

Federated Learning (FL) and Distributed Learning (DL) are decentralised ML frameworks that aim to parallelise the training process using multiple connected computer devices simultaneously, to train a single model. Edge devices are pieces of hardware in a network (e.g. in the IoT) that provide an entry point to the network and that can constantly collect raw data. In some scenarios, IoT devices may be limited in terms of network quality. In these cases, communication will need to be restricted further to allow for consistent training.

Deep learning is a subset of ML where large datasets are used to train ML models in the form of neural networks (NNs). A neural network is a connected system of functions whose structure is inspired by the human brain. Multiple nodes are interconnected with each connection able to transmit data like signals transmitted via synapses. Connections between nodes carry weights which are the parameters being optimised, consequently training the model.

### BRIEF DESCRIPTION OF THE DRAWINGS

Arrangements of embodiments will be understood and appreciated more fully from the following detailed description, made by way of example only and taken in conjunction with drawings in which:

FIG. 1 shows a system architecture for implementing federated learning according an arrangement;

FIG. 2 shows a flowchart detailing a federated learning method with a full local model update from workers and full global updates from a server;

FIG. 3 shows a flowchart detailing a method for federated learning with a reduced update size according to an implementation;

FIG. 4 shows a flowchart detailing training update steps of the method of FIG. 3;

FIGS. 5A to 7B show plots of different performance metrics for different parameter pruning methods;

FIGS. 8A to 9B show plots of different performance metrics for different federated machine learning methods; and

FIG. 10 shows a computing device for putting the methods described herein into practice.

### DETAILED DESCRIPTION

Implementations described herein provide improvements to federated learning by compressing a size of each update sent between nodes within a distributed system. This may result in a reduction of an overall amount of data transmitted during a training phase of the distributed system. Specific implementation adjust the size of each update based on a quality of service of a communication link over which the update is sent.

This makes efficient use of network capacity, e.g. by allowing larger updates to be sent in response to an increase of the quality of service and reducing the size of updates in response to a decrease of the quality of service.

According to an aspect of the present disclosure there is provided a computer-implemented method for training a machine learning model in a distributed system. The distributed system comprises a plurality of nodes that exchange updates to communally train the machine learning model. Each node of the plurality of nodes maintains a local version of the machine learning model. The local version of the machine learning model of each of the plurality of nodes has been initialised with the same one or more respective parameter values. The method comprises a node: receiving an update to a local model from at least one other node in the distributed system, the local model comprising the local version of the machine learning model and the update comprising a dense array of one or more first parameter deltas, the one or more first parameter deltas being ordered in the dense array in an order determined by a reference model, each first parameter delta representing a difference between a parameter of the local model and a corresponding parameter of an updated version of the machine learning model that is maintained by the at least other node; updating the local model based on the received update and the reference model to determine an updated local model; determining one or more second parameter deltas, each second parameter delta representing a difference between a parameter of the updated local model and a corresponding parameter of a previous version of the local model; and sending an update to the at least one other node in the distributed system, wherein the update comprises a dense array of the one or more second parameter deltas, the one or more second parameter deltas being ordered in the dense array in an order determined by the reference model.

By receiving an update comprising the dense array of the one or more first parameter deltas from the at least one other node and by sending an update comprising the dense array of the one or more second parameter deltas to the at least one other node, the one or more first parameter deltas and the one or more second parameter deltas being ordered in the respective dense array in an order determined by a reference model, the inclusion of one or more full parameters and/or one or more corresponding parameter identifiers may not be necessary. This may allow for the size of each update to be reduced. This may also allow for a number of first and second parameter deltas to be included in each respective update to be increased without increasing the size of the respective update.

The one or more first parameter deltas may be ordered in the dense array according to a magnitude of one or more corresponding parameters of the reference model. The one or more second parameter deltas may be ordered in the dense array according to a magnitude of one or more corresponding parameters of the reference model.

The plurality of nodes may comprise a plurality of workers and a server. Each of the plurality of workers may be configured to train a respective local model and report updates to the local model back to the server. The server may be configured to aggregate updates from the workers to update a global model. The server may be configured to report updates to the global model back to the workers. The server may be configured to aggregate the updates from the workers based on the reference model.

The reference model may comprise a copy of a previous version of the global model. For example, the reference model may comprise a copy of a version of the global model that precedes an updated version of the global model at the server.

The node may be a worker and the method may comprise receiving the update to the local model from the server. The one or more first parameter deltas may be indicative of a current state of every updated parameter of the global model. Updating the local model may comprise applying the update to the local model to bring the local model into compliance with the global model.

The node may be a worker and the method may comprise determining a level of reduction of a number of parameters of the local model. One or more parameters of the local model to be removed or pruned may be randomly selected. As such, no pre-training of the local model and/or training data, e.g. to select the one or more parameters to be removed or pruned, may not be needed.

The method may comprise applying the determined level of reduction of the number of parameters to the local model to produce a reduced local model. The method may comprise applying the determined level of reduction of the number of parameters of the local model to the reference model. This may allow the reference model to act as a mask, e.g. when the local model is updated based on the update received by the at least one other node and/or during aggregation of the updates from the workers.

The method may comprise training the reduced local model based on training data to obtain the updated local model. The step of training the reduced local model may be part of or comprised in the step of updating the local model.

The method may comprise sending the update to the server for use in updating the global model.

Determining the level of reduction of the number of parameters of the local model may comprise determining a quality of service of a communication link between the worker and the server. Determining the level of reduction of the number of parameters of the local model may comprise determining the level of reduction of the number of parameters of the local model based on the quality of service.

The method may comprise adjusting the level of reduction of the number of parameters of the local model based on the quality of service. Adjusting the level of reduction of the number of parameters of the local model based on the quality of service may comprise decreasing the level of reduction of the number of parameters of the local model in response to an increase of the quality of service. Adjusting the level of reduction of the number of parameters of the local model based on the quality of service may comprise increasing the level of reduction of the number of parameters of the local model in response to a decrease of the quality of service.

For example, when the level of reduction of the number of parameters of the local model is decreased, applying the determined level of reduction of the number of parameters to the local model may comprise including one or more additional parameters in the local model. The one or more additional parameters to be included in the local model may be determined based on the reference model.

The local model may comprise a plurality of layers. Applying the determined level of the reduction of the number of parameters to the local model may comprises distributing the reduced number of parameters across the plurality of layers, e.g. such that each of the plurality of layers comprises a same number or an equal number of parameters. As such, the method disclosed herein may allow for layer-wise pruning, e.g. based on the determined level of the reduction of the number parameters of the local model, which may also be understood as a global pruning level.

Additionally, by distributing the reduced number of parameters across the plurality of layers such that each of the plurality of layers comprises the same number or an equal number of parameters, one or more smaller layers of the local model may be less affected by the global pruning level that one or more relatively larger layers of the local model.

When at least one layer of the plurality of layers of the local model is full, applying the determined level of the reduction of the number of parameters to the local model may further comprise excluding the at least one layer from a further distribution of the reduced number of parameters. When at least one layer of the plurality of layers of the local model is full, applying the determined level of the reduction of the number of parameters to the local model may further comprise distributing the reduced number of parameters across one or more remaining layers of the plurality of layers of the local model, e.g. such that each of the one or more remaining layers of the plurality of layers of the local model comprises a same number or an equal number of parameters.

The reference model may comprise a plurality of layers. Applying the determined level of the reduction of the number of parameters to the reference model may comprise distributing the reduced number of parameters across the plurality of layers of the reference model, e.g. such that each of the plurality of layers of the reference model comprises a same number or an equal number of parameters. One or more parameters of each of the plurality of layers of the reference model may correspond to one or more parameters of each of the plurality of layer of the local model.

When at least one layer of the plurality of layers of the reference model is full, applying the determined level of the reduction of the number of parameters to the reference model may further comprise excluding the at least one layer from a further distribution of the reduced number of parameters. When at least one layer of the plurality of layers of the reference model is full, applying the determined level of the reduction of the number of parameters to the reference model may further comprise distributing the reduced number of parameters across one or more remaining layers of the plurality of layers of the reference model, e.g. such that each of the one or more remaining layers of the plurality of layers of the reference model comprises a same number or an equal number of parameters.

The method may further comprise sending by the worker a full update of the local model representing the current state of every parameter of the local model, e.g. when the quality of service exceeds an upper threshold. The method may further comprise omitting sending of the update by worker, e.g. when the quality of service is below a lower threshold.

The node may be the server. The local model maintained by the node may be the global model that is locally maintained by the server. Receiving an update to a local model may comprise receiving a plurality of updates from the plurality of workers. Each update may comprise a dense array of one or more second parameter deltas. Updating the local model may comprise aggregating the updates from the plurality of workers to update the global model based on the reference model. The update may be sent by the server to each of the workers for use in updating their respective local models.

The one or more second parameter deltas may be indicative of the current state of every updated parameter of the global model.

The local version of the machine learning model of each of the plurality of nodes may be randomly initialised with the same one or more respective parameter values. For example, in a first iteration of the method, the update received from the at least one other node may be used to initialise the local model. In the first iteration, the update received from the at least one other node may comprise a random seed, e.g. to randomly initialise a local model.

According to a further aspect of the present disclosure there is provided a node for use in a distributed system. The distributed system comprises a plurality of nodes that exchange updates to communally train a machine learning model. Each node of the plurality of nodes maintains a local version of the machine learning model. The local version of the machine learning model of each of the plurality of nodes has been initialised with the same one or more respective parameter values. The node comprises storage configured to store a local model comprising the local version of the machine learning model; and a processor configured to: receive an update to a local model from at least one other node in the distributed system, the update comprising a dense array of one or more first parameter deltas, the one or more first parameter deltas being ordered in the dense array in an order determined by a reference model, each first parameter delta representing a difference between a parameter of the local model and a corresponding parameter of an updated version of the machine learning model that is maintained by the at least other node; update the local model based on the received update and the reference model to determine an updated local model; determine one or more second parameter deltas, each second parameter delta representing a difference between a parameter of the updated local model and a corresponding parameter of a previous version of the local model; and send an update to the at least one other node in the distributed system, wherein the update comprises a dense array of the one or more second parameter deltas, the one or more second parameter deltas being ordered in the dense array in an order determined by the reference model.

According to a further aspect of the present disclosure there is provided a non-transitory computer-readable medium comprising computer executable instructions that, when executed by a computer, configure the computer to act as a node within a distributed system. The distributed system comprises a plurality of nodes that exchange updates to communally train a machine learning model. Each node of the plurality of nodes maintains a local version of the machine learning model. The local version of the machine learning model of each of the plurality of nodes has been initialised with the same one or more respective parameter values. The computer executable instructions cause the computer to: receive an update to a local model from at least one other node in the distributed system, the local model comprising the local version of the machine learning model and the update comprising a dense array of one or more first parameter deltas, the one or more first parameter deltas being ordered in the dense array in an order determined by a reference model, each first parameter delta representing a difference between a parameter of the local model and a corresponding parameter of an updated version of the machine learning model that is maintained by the at least other node; update the local model based on the received update and the reference model to determine an updated local model; determine one or more second parameter deltas, each second parameter delta representing a difference between a parameter of the updated local model and a corresponding parameter of a previous version of the local model; and send an update to the at least one other node in the distributed system, wherein the update comprises a dense array of the one or more second parameters, the one or more second parameters being ordered in the dense array in an order determined by the reference model.

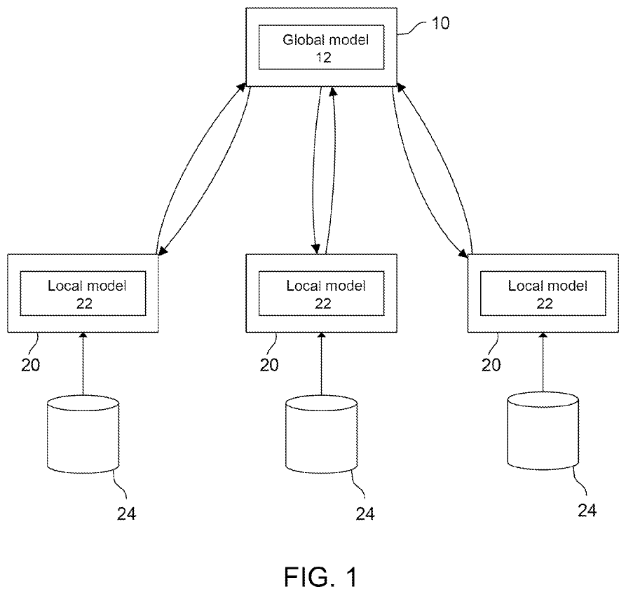

FIG. 1 shows a system architecture for implementing federated learning (FL) according an arrangement. The system architecture contains a Parameter Server (PS) node 10 and multiple worker nodes 20. A global model 12 comprising one or more parameters is stored at the server 10. Worker nodes 20 contribute to training the global model 12.

In the following description, the Parameter Server node will be referred to as a server and the worker nodes will be referred to as workers.

In this architecture, workers 20 send model updates to the server 10. These updates are aggregated at the server 10 to update the global model 12. The parameters of the updated global model are then communicated back to each worker 20.

More specifically, each worker 20 stores a local model 22. This local model 22 is a locally maintained version of the global model 12. Each local model 22 is periodically updated to match the global model 12 based on updates transmitted from the server 10 to the workers 20.

Each worker 20 trains the local model 22 based on locally available training data 24. This training data 24 may be unique to the respective worker node 20 and may either be stored in memory (e.g. from earlier measurements) or may be received in real time (e.g. from sensor readings).

Each worker 20 can train the local model 22 through one or more updates to the local model 22 based on the training data. In general, training involves adjusting the parameters (the weights) of the local model 22, which can be implemented as a neural network (NN), to optimise some function (e.g. to reduce the error). Gradient Descent (GD), such as Stochastic Gradient Descent, is one optimisation approach for learning weights of a neural network (NN), although other methods for parameter optimization are available.

After training the local models, the workers 20 communicate parameter updates to the server 10, which aggregates the parameter updates across the workers 20 and applies this to update the global model 12.

The parameter updates reported back to the server 10 can include updated parameters of the local model 22, which can then be used by the server 10 to determine updates to the global model 12. Aggregation of the updates could be in the form of taking an average (e.g. mean or median) across the updates, or may be through any other form of aggregation.

Once the global model 12 has been updated, updated parameters of the global model 12 can be communicated back to the workers 20 to allow them to update their respective local models 22.

Updates may be exchanged after each step of training on the local models, or multiple training steps may be performed before the global model is updated. Updating the global model after each step of local model training may ensure that the local models do not diverge from each other. Updating after a few optimisation iterations may reduce the number of updates that need to be transferred.

Each iteration of updating the global model 12 includes the transmission of updates from the workers 20 to the server 10 and the transmission of the parameters of the global 12 model back to the workers 20. The communication of large amounts of data through the network can be a major bottleneck in large scale federated learning model training. In potential applications, devices may be limited in terms of permitted energy usage, communication bandwidth (BW) and other network resources. This may hinder participation in federated learning model training, as the network quality of service would be insufficient to withstand such quantities/rates of data transfer. It is of interest to keep these federated learning workers/nodes/agents/server connected and ensure they are still able to engage in the training process.

It should be noted that whilst the present implementation has a separate server to the workers, the server may also be a worker and therefore may also perform local training either directly on the global model or as an emulated worker that updates a separate local version and aggregates its own updates with updates from other workers.

The present application proposes a novel adaptive federated learning model parameter compression method to reduce the overall amount of data transmitted during the training phase of a distributed system.

In the parameter compression method described herein, the parameters of the global model 12 and each local model 22 are initialised with the same respective values. For example, the global model 12 and each of the local models 22 can be randomly initialised with the same parameter values. Each update sent by the worker 20 includes a dense array of one or more parameter deltas. Each parameter delta represents a difference between a parameter of the updated local model 22 and a corresponding parameter of a previous version of the local model 22. The parameter deltas sent by the worker may also be referred to as second parameter deltas.

The dense array of parameter deltas can be understood as an array of parameter deltas were most of the parameter delta values are non-zero or unequal to zero. The dense array of parameter deltas may also be referred to as a non-sparse array of parameter deltas. The parameter deltas are ordered in the dense array in an order determined by a reference model. By including a dense array of parameter deltas in each update sent by the worker 20, the sending of full parameters may be avoided. As each update sent by the worker 20 includes the dense array of parameter deltas in the order determined by the reference model, the sending of identifiers for the parameter deltas (e.g. the indices for the relevant parameter weights), which may enable the server to determine with which respective parameters of the local model the parameters deltas are associated, may not be necessary. Instead, the reference model is used to reconstruct the local model 22 of each worker 20 during aggregation.

As well as compressing updates from workers 20 to the server 10, the same compression strategy can be implemented when sending an update to a local model from the server 10 to the workers 20. Each update to each worker 20 includes a dense array of one or more parameter deltas. Each parameter delta represents a difference between a parameter of the local model 22 and a corresponding parameter of an updated version of the global model 12. The parameter deltas are indicative of the current state of every updated parameter of the global model 12. The parameter deltas sent by the server may also be referred to as first parameter deltas.

The parameter deltas are ordered in the dense array in an order determined by the reference model. The local model 22 is updated based on the received update and the reference model. The update is applied to the local model 22 to bring the local model 22 into compliance with the global model 12. For example, the parameter deltas may be added to the corresponding parameters of the local model 22.

The reference model comprises a copy of a version of the global model that precedes the updated version of the global model at the server. In this implementation, the parameter deltas in the dense array are ordered according to a magnitude of each of the corresponding parameters in the reference model. For example, the parameter deltas in the dense array can be ordered in a descending order according to the magnitude of each of the corresponding parameters in the reference model. The term “magnitude” as used herein can be understood as an absolute value of a parameter or L1 norm or measure.

The parameter compression method proposed herein may allow for a size of each update transmitted between the workers and the server to be reduced. Additionally, a number of parameter deltas to be included in each update may be increased without increasing the size of the update. As such, updates may be transmitted between the workers and the server more often and/or more efficiently.

It will be appreciated that in other implementations, the parameter deltas in each of the above-mentioned updates may be replaced by one or more corresponding parameters. For example, each update may comprise a dense array of one or more changed or updated parameters, which are ordered in an order determined by the reference model. Any of the features described herein in relation to the parameter deltas may also apply to the corresponding parameters.

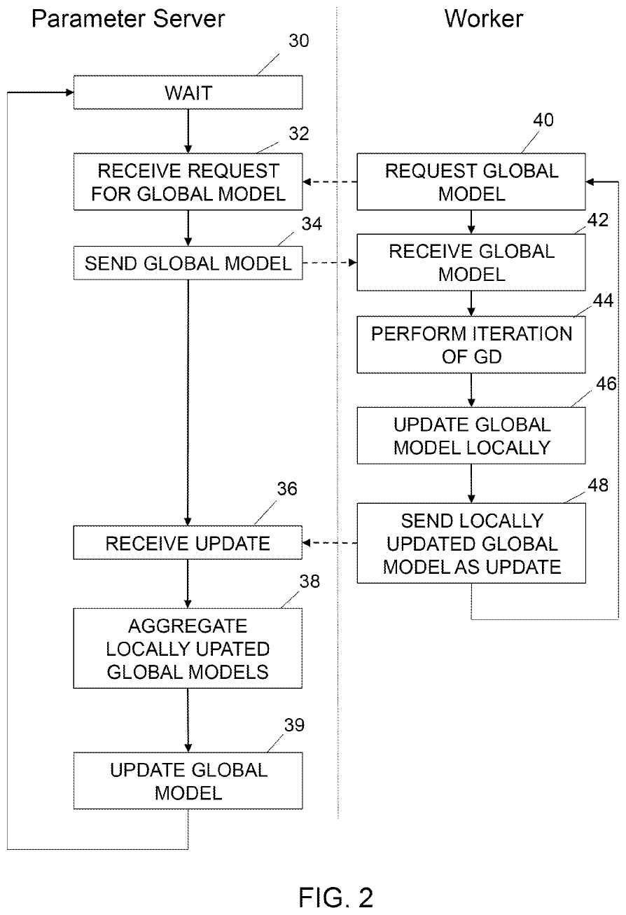

FIG. 2 shows a flowchart detailing a federated learning method with a full local model update from workers and full global updates from a server. Operation for a parameter server and a single worker node is displayed with the dotted line representing a network interface between the two. Solid arrows represent communication within the node (e.g. the respective server or worker) whereas dashed arrows represent communication across the network to the other node.

The method begins with the server waiting 30 for a request from a worker for an update. When an update request 40 is sent by a worker and received 32 by the server then the server sends a full global model 34 to the respective worker.

When the worker receives the full global model 42 it replaces the local model stored at the worker with the global model and performs a training update on the global model 44. This training update adjusts the parameters according to an optimisation method. In the present example, gradient descent is used to update the global model parameters based on training data that is available to the worker. The global model is therefore updated locally to produce new model parameters from the training 46.

The worker then sends the full locally updated global model 48 as an update to the server. The worker then loops back to step 40 to send a request for a further update from the server.

When the server receives the update 36, it aggregates 38 the locally updated global model with other locally updated global models received from other workers and updates the global model based on the aggregate 39. The server then moves loops back to step 30 to wait for a further request from a worker.

This method can put a large strain on the network as the server sends the global model to each worker and each worker sends the full locally updated global model back to the server regardless of network conditions. Accordingly, as described earlier, the methodology proposed herein instead includes the transmission of a dense array of parameter deltas to reduce an update size sent between the server and the worker.

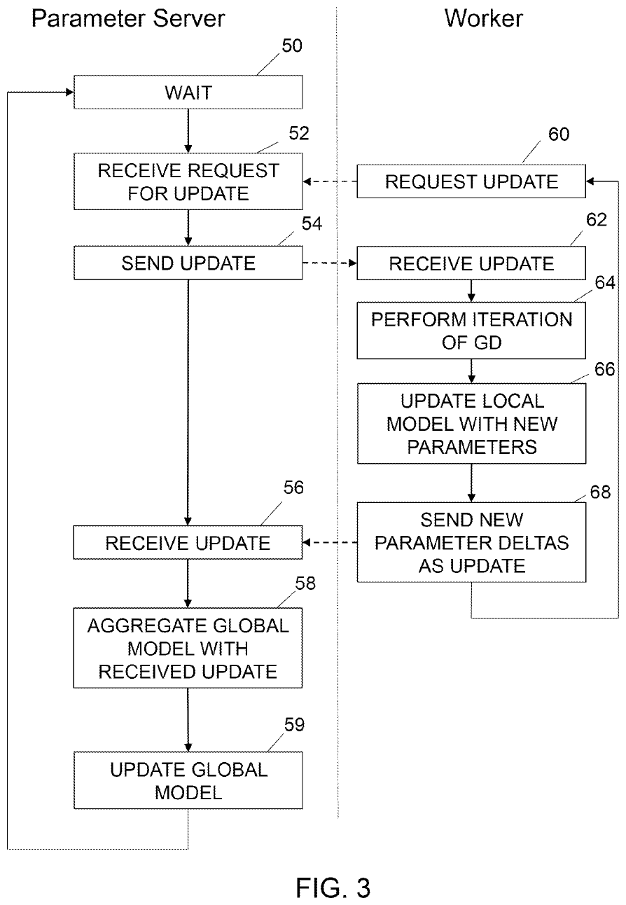

FIG. 3 shows a flowchart detailing a method for federated learning with a reduced update size according to an implementation. The methodology is similar to that shown in FIG. 2.

As with FIG. 2, operation for a parameter server and a single worker node is displayed with the dotted line representing a network interface between the two. Solid arrows represent communication within the node (e.g. the respective server or worker) whereas dashed arrows represent communication across the network to the other node.

The method starts with the server waiting 50 for a request from a worker 60 for an update. When an update request 60 is sent by a worker and received 52 by the server then the server sends the update to the worker.

In a first iteration of the method, the update can include a random seed, e.g. to randomly initialise a local version of the global model on the worker. The server sends this update to each worker so that the global model and the local version of the global model on each worker are initialised with the same respective parameter values. The local version of the global model may also be referred to as a local model.

In subsequent iterations of the method, the update includes parameter deltas. The update may be considered as only including parameter deltas associated with parameters to be updated. The parameter deltas are provided to the worker as the dense array of parameter deltas. An order of the parameter deltas in the dense array is determined by the reference model, as described above.

In the first iteration of the method, when the worker receives the update 62, it initiates the parameter values of the local version of the global model stored at the worker, as described above, and performs a training update on the local version of the global model 64.

In subsequent iterations of the method, when the worker receives the update 62, it applies the update to the local model to bring the local model into compliance with the global model. For example, the worker is configured to determine one or more updated parameters of the local model based on the parameter deltas and the reference model. The worker may be configured to use the reference model to determine which parameters of the local model are associated with the received parameter deltas, e.g. based on the magnitude of the corresponding parameters of the reference model. The worker may be configured to add the parameter deltas to the associated parameters of the local model to determine the updated parameters of the local model on the worker. The worker is configured to replace the corresponding parameters of the local model with the determined updated parameters, thereby bringing the local model into compliance with the global model. In this implementation, the reference model may be used as a mask to reconstruct the local model stored at the worker. The mask may also be referred to as a deterministic mask. The worker performs a training update on the local model 64.

This training update adjusts the parameters according to an optimisation method. In the present example, Gradient Descent, such as Stochastic Gradient Descent, is used to update the parameters of the local model based on training data that is available to the worker. It will be appreciated that in other implementations another method for parameter optimization may be used. The local model is, therefore, updated to produce new model parameters from the training 66. The new model parameters include parameters that have changed during training update 64.

The worker is configured to determine new parameter deltas. Each new parameter delta represents a difference between a new parameter of the updated local model and a corresponding parameter of a previous version of the local model. The worker is configured to send the new parameter deltas as an update 68 to the server. The new parameter deltas are provided to the server as a dense array of new parameter deltas, as described above. An order of the new parameter deltas in the dense array is determined by the reference model. The worker then loops back to step 60 to send a request for a further update from the server.

When the server receives the update 56, the server keeps a copy of the current version of the global model stored at the server. The server may be configured to determine new model parameters based on the received new parameter deltas and the reference model, which corresponds to the current version of the global model at the server. The server may be configured to use the reference model to determine which parameters of the global model are associated with the received new parameter deltas. The server may be configured to add the received new parameter deltas to the associated parameters of the global model to determine new parameters of the global model. The server is configured to then aggregate 58 the new model parameters with other new model parameters determined based on new parameter deltas received from other workers and the reference model. The server is configured to update the global model based on the aggregate 58.

The dense arrays of parameter deltas received by the server from the workers can have different sizes. As such, two or more sets of new parameters determined based on the received dense arrays of parameter deltas and the reference model can have different sizes. The server can be configured to aggregate one or more overlapping new parameters and/or one or more non-overlapping new parameters based on the number of workers associated with the received dense arrays of parameter deltas.

The server reconstructs a local model associated with each worker based on the reference model, e.g. the copy of the version of the global model that the server kept at step 56, and the new parameters determined for each worker during the aggregation step 58. As described above, the server may be configured to use the reference model as a mask, e.g. a deterministic mask, to reconstruct the local model of each worker. The server then loops back to step 50 to wait for a further request from a worker.

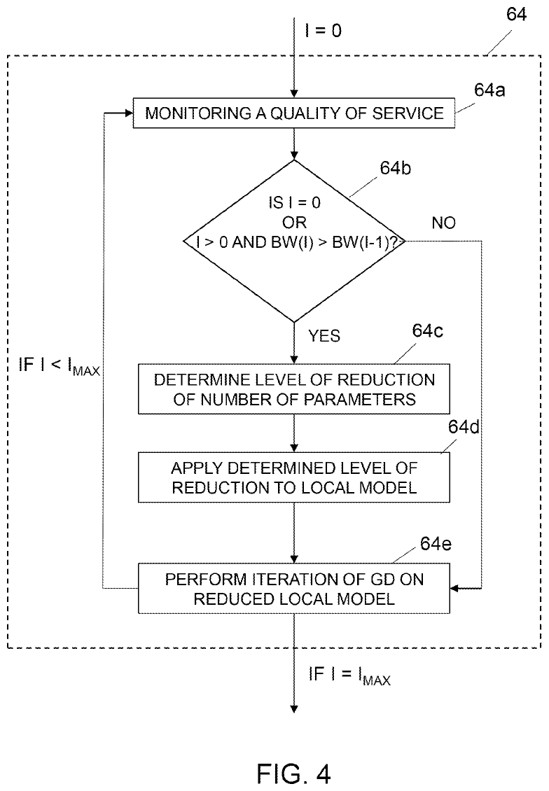

FIG. 4 shows a flowchart detailing training update steps 64a to 64e of the method shown in FIG. 3. The training update steps can be performed for a number of iterations I. At the start of the method, the number of iterations I is set to zero.

A quality of service of a communication link between the server and the worker is monitored 64a. The quality of service may also be referred to as a network quality. The quality of service can be defined in terms of a number of different metrics, such as bandwidth, signal to noise ratio, channel quality, received signal strength, error rate, network availability, etc. In this implementation, a bandwidth BW of the communication link between the server and the worker is monitored and/or determined.

Active probing or passive monitoring techniques can be used to determine the bandwidth of the communication link between the server and the worker. Active probing may include the sending of one or more data packets having a known size from the worker to the server and measuring a duration of time until the data packets are received by the server and acknowledgement of receipt is received from the server by the worker. The worker is configured to determine the bandwidth based on the measured duration of time and the data packet size. For example, the worker can be configured to determine the bandwidth by dividing the data packet size by the duration of time.

For passive monitoring, the worker may be configured to monitor on-going communication with the server. The on-going communication may include the sending and/or receiving of the updates described above. For example, the worker may be configured to determine the bandwidth based on a data transfer rate observed during this communication.

When the number of iterations I equals zero 64b, a level of reduction of a number of parameters of the local model stored at the worker is determined 64c. The level of reduction of the number of parameters of the local model may also be referred to as a pruning level of the local model. Pruning may comprise removing one or more parameters from the local model. The level of reduction of the number of parameters of the local model is determined based on the determined bandwidth. The level of reduction of the number of parameter of the local model can be adjusted based on the determined bandwidth, as will be described in more detail below.

The level of reduction of the number of parameters of the local model can be understood as a global pruning level of the local model. The global pruning level is based on a total number of parameters of the local model. The global pruning level may be set by a global pruning parameter k=1−C, where C is a data compression ratio. The data compression ratio can be defined as a ratio between the uncompressed data rate and the compressed data rate. The data compression ratio C can be determined as follows:

$$C = min ( \frac{R \cdot σ}{size ( θ )} ) . \qquad ( Equation 1 )$$

In the present implementation, the data compression ratio C is determined using active probing. However, it will be appreciated that in other implementations, the data compression ratio may be determined using passive monitoring, for example as described above. The data compression ratio C can be determined based on a maximum data rate R, which is measured in bits per second, a duration of time σ assigned to the worker to send the update to the server, which is measured in second, and a size of the full local model size(θ), which is measured in bits. The duration of time σ can be understood as a hyperparamter of the local model. This hyperparamter can be differently determined. For example, in an implementation, the duration of time σ is determined based on an expected data rate and an allocated transmission costs to send an update between the server and the worker. In this implementation, the duration of time can be determined as follows:

$$σ = \frac{\frac{{c}_{k}}{{c}_{bit}}}{E [ R ]} \qquad ( Equation 2 )$$

where E[R] is the expected data rate, Cₖ is an allocated transmission costs per worker, which is valued in a currency, and C_{bit} is a cost per transmitted bit.

In another implementation, the duration of time can be determined based on a maximum allowable time duration σₘₐₓ. In some implementations, there can be a large difference between a bandwidth of a communication link between the server and a worker and another bandwidth of another communication link between the server and another worker. The duration of time σ may be based on the maximum duration of time σₘₐₓ assigned to a worker associated with a communication link with the server having a bandwidth that is lower than a bandwidth of another communication link with the server associated with another worker.

The compression ratio can be bounded. For example, an upper threshold of the compression ratio can be determined. When the compression ratio C exceeds the upper threshold, the update includes a full update of the global model representing the current state of every parameter of the global model or a full update of the local model representing the current state of every parameter of the local model. For example, in implementations where C>1, the update can include the full update. In such, implementations, the full update includes an uncompressed copy of the global model or the local model.

A lower threshold of the compression ratio can be determined. For example, in implementations where C→0, the sending of an update may be inefficient. When the compression ratio C is below the lower threshold, a worker or the server may not send an update until the maximum data rate R increases. As such, the worker or server omits sending of the update. The lower threshold of the compression ratio C can be selected to be between 0.03 to 0.1, such as 0.05.

The determined level of reduction of the number of parameters is applied to the local model 64d stored at the worker. For example, a total number of parameters of the local model is reduced. The determined level of reduction of the number of parameters can also be applied to the reference model such that the reference model can be used as a mask, e.g. when reconstructing the local model and/or global model during aggregation.

The local model comprises a plurality of layers. The reduced number of parameters are distributed across the layers of the local model such that each of the layers comprises a same number or an equal number of parameters.

The reduced number of parameters may be distributed based on an order determined by a number of parameters of each of the layers. For example, the reduced number of parameters may be distributed in an ascending order of the number of parameters of each layer of the local model. An equal portion of the number of reduced parameter may be allocated to each layer of the local model. The portion of the reduced number of parameter may be first allocated to the layer with the smallest number of parameters.

When at least one of the layers is full, the full layer is excluded from a further distribution of the reduced number of parameters. For example, no further parameters are allocated to the full layer. For example, if the smallest layer cannot accommodate the allocated number of reduced parameter, it is considered as full. The allocation of a remainder of the reduced number of parameters to the remaining layers is then determined. The remainder of the reduced number of parameters can then be distributed across one or more remaining layers of the local model, e.g. such that the remaining layers comprise a same number or an equal number of parameters. A layer of the local model can be considered as full, when a number of parameters allocated to this layer equals to a number of parameters of this layer. It will be appreciated that when a layer of the local model is considered as full, the number of parameters allocated to each of the remaining layers is increased relative to the number of parameters of the full layer, e.g. by the number of parameters that could not be allocated to the full layer.

The distribution of the reduced number of parameters can be as set out in the following. A is an ordered set of the number of parameters for every layer of the local model stored at the worker and is defined as follows:

$$A = \{ {a}_{n} ∈ {ℕ}^{+} : {a}_{n + 1} \geq {a}_{n} ∀ n ∈ I \} , \qquad ( Equation 3 )$$

where I={1, 2, . . . , N} is an ordered set of N indices and an represents the parameters.

The number of reduced parameters θ is defined as:

$$θ = ⌊ k {\sum }_{{a}_{n} ∈ A} {a}_{n} ⌉ \qquad ( Equation 4 )$$

where k=(1−C), as described above, and kϵ[0,1]. The reduced number of parameters θ is rounded to the closest integer. It can be seen that the reduced number of parameters θ depends on the compression ratio C, described above, and as such, the bandwidth of the communication link between the worker and the server. As such, a reduction of the parameters per layer depends on the global pruning parameter k, which in turn depends on the compression ratio C.

A reduced number of parameters φₙ for a layer n that includes parameters an is defined as follows:

$$φ ( n ) = \{ \begin{matrix}{\sum }_{j = 1}^{n - 1} {φ}_{j} , n > 0 \\ 0 , n = 1\end{matrix} , ∀ n ∈ I , \qquad ( Equation 5 )$$

where:

$${φ}_{n} = min ( {a}_{n} , ⌊ \frac{Θ - φ ( n )}{\vert A \vert - n + 1} ⌉ ) \qquad ( Equation 6 )$$

are the parameters to be distributed up to layer n. φ(n) in Equation 3 defines a sum of previous parameters φⱼ. Equation 6 defines the distribution of the number of reduced parameters φₙ to each layer n with parameters aₙ.

It will be appreciated that when φₙ equals A for a layer n, the layer n is considered to be a full layer.

An exemplary process of the distribution of the reduced number of parameters is set out in Algorithm 1:

```
Algorithm1:
Require: A, k ∈ [0, 1], Φ = 0
  θ = └(1 − k)Σₐ_{ₙ}_{∈A} aₙ┘ ⊖ is a constant that describes the reduced
number of parameters to distribute
for n in {1, 2, . . . , |A|} do
  ${φ}_{n} ← min ( ⌊ \frac{θ - {\sum }_{φ ∈ Φ} φ}{\vert A \vert - n + 1} ⌉ )$
  Φ := Φ ∪ {φₙ}
end for
```

Additionally or alternatively, the reduced number parameters can be distributed across the layers of the local model by creating a map, which can be in the form of:

$$f : \to 1 - \frac{{φ}_{n}}{{a}_{n}} ∈ [ 0 , 1 ] . \qquad ( Equation 7 )$$

Equation 7 can be considered as mapping the number of parameters to a reduced number of parameters per layer of the local model.

The above distribution of the reduced number of parameters is also applied to the reference model. For example, the reference model comprises a plurality of layers and the reduced number of parameters are distributed across the layers of the reference model in the same manner as across the layers of the local model described above. Once the distribution of the reduced number of parameters of the reference model has been determined, one or more parameters of the reference model that correspond to the parameters removed from the local model may also be removed from the reference model. As such, one or more parameters of each of the layers of the reference model correspond to one or more parameters of each of the plurality of layer of the local model. This allows the reference model to be used as a reference or mask for reconstructing the global model stored at the server and the local version of the global model stored at the worker.

Pruning methods may be used to reduce an overall amount of data transmitted during the training phase of a distributed system. For example, a global pruning method can be used to remove a percentage of parameters across the whole of a machine learning model. This can result in smaller layers of the machine learning model being more affected by the pruning, especially for high pruning levels, such as a 99% or more removal of the parameters of the machine learning model. For example, a convolutional neural network, such as LeNet-5 or the like, can include a convolutional kernel and a fully connected neural network, each having different dimensions. When a high pruning level, such as 99.9%, is to be achieved, the convolutional kernel and the fully connected neural network are differently affected by the pruning level. Depending on the dimensions of the convolutional kernel and the fully connected neural network, a probability of setting all parameter values in, for example a column in the fully connected neural network to zero, can be significantly lower than a probability of setting all parameter values in, for example a column in the convolutional kernel to zero.

Structured pruning can allow for different pruning levels for different layers of the machine learning model to be defined. However, it can be difficult to adjust a pruning of the layers to achieve a desired global pruning level. Additionally, when the global pruning level changes, it may be necessary to individually adjust the pruning levels of the different layers.

Other pruning methods, for example based on an assessment of an importance of a parameter, such as an absolute value of the parameter or an Euclidian norm of a substructure, e.g. a channel, filter, layer or other substructure of the machine learning model, can require the machine learning model to be trained or at least partially trained prior to pruning. This would require sending a full model update of the local model in a first iteration of a federated learning method, e.g. as described above in relation to FIG. 2.

The present application proposes a novel pruning method, which is part of the parameter compression method described herein. The pruning method disclosed herein does not require pre-training of a machine learning model or training data, e.g. to select one or more parameters to be maintained in the machine learning model. Instead, the steps of determining the level of reduction of the number of parameters 64c and/or applying the determined level of reduction of the number of parameters 64d, as described above, can be performed prior to training the local model or during training of the local model. The parameters of the local model to be removed or pruned are randomly selected, which may allow higher sparsity levels to be achieved, e.g. compared to the pruning methods that are based on the assessment of the magnitude, importance and/or other attribute of a parameter.

The number of reduced parameters on for a layer n, e.g. as defined in Equation 6, can be adaptively adjusted based on the determined bandwidth, of the communication link between the server and worker. The pruning method disclosed herein can, therefore, produce layer-wise pruning levels for changing global pruning levels, e.g. for a changing bandwidth.

As described above, the reduced number of parameters are distributed across the layers such that each of the layers comprises the same number or equal number of parameters. This may avoid one or more small layers of the local version of the global model being more affected by the global pruning level than one or more relatively large layers of the local model, while allowing the global pruning level to be achieved.

The pruning method described herein may be used with any machine learning model and does not require a specific architecture or structure of the machine learning model.

The reduced local model is trained based on training data that is available to the worker 64e. This training adjusts one or more parameters of the reduced local model according to an optimisation method. In the present example, Gradient Descent, such as Stochastic Gradient Descent, is used to update the reduced local model parameters based on training data that is available to the worker. The one or more parameters of the reduced local model to be adjusted during training can be selected based on an attribute or measure, e.g. a magnitude, of each parameter of the reduced local model. For example, one or more parameters of each layer of the reduced local model may be selected for training based on the magnitude of each parameter of the reduced local model. For example, only parameters with the largest magnitude per layer of the reduced local model may be adjusted during training. It will be appreciated that in other implementations, another attribute or measure, e.g. such as the L2 norm, may be used to select one or more parameters of the reduced local model to be trained.

If the number of iteration I is below a predetermined maximum number of iterations IMAX, the worker loops back to step 64a. If the number of iterations equals the maximum number of iterations IMAX, the worker proceeds to step 66 shown in FIG. 3 and described above. The maximum number of iterations may be selected based on a desired accuracy of the local model and/or a stopping parameter, e.g. when an accuracy of the local model does not improve.

For any subsequent iterations, e.g. I>0, and when the bandwidth BW(I) determined for the present iteration is equal to or smaller than the bandwidth BW(I−1) determined for a previous iteration, the worker proceeds to step 64e. However, for any subsequent iterations, e.g. I>0, and when the bandwidth BW(I) determined for the present iteration is larger than the bandwidth BW(I−1) determined for the previous iteration, the worker proceeds to step 64c.

As described above, the level of reduction of the number of parameters of the local model can be adjusted based on the determined bandwidth. For example, in response to an increase in the bandwidth, the level of reduction of the number of parameters of the local model can then be decreased in step 64c. Expressed differently, the global pruning level can be decreased. One or more additional parameters can then be included into the local model. The additional parameters to be included in the local model can be determined based on the reference model. For example, one or more locations of the additional parameters to be included may be selected based on the reference model. In response to a decrease in the bandwidth, the level of reduction of the number of parameters of the local model can be increased. As such, the level of reduction of the parameters can be adjusted based on the determined bandwidth. This may also be referred to as adaptive pruning of the local model. Although in this implementation, the level of reduction of the number of parameters of the local model is adjusted based on the determined bandwidth, it will be appreciated that in other implementations the level of reduction of the number of parameters may be adjusted based on another metric, such as the signal to noise ratio, channel quality, received signal strength, error rate, network availability, etc.

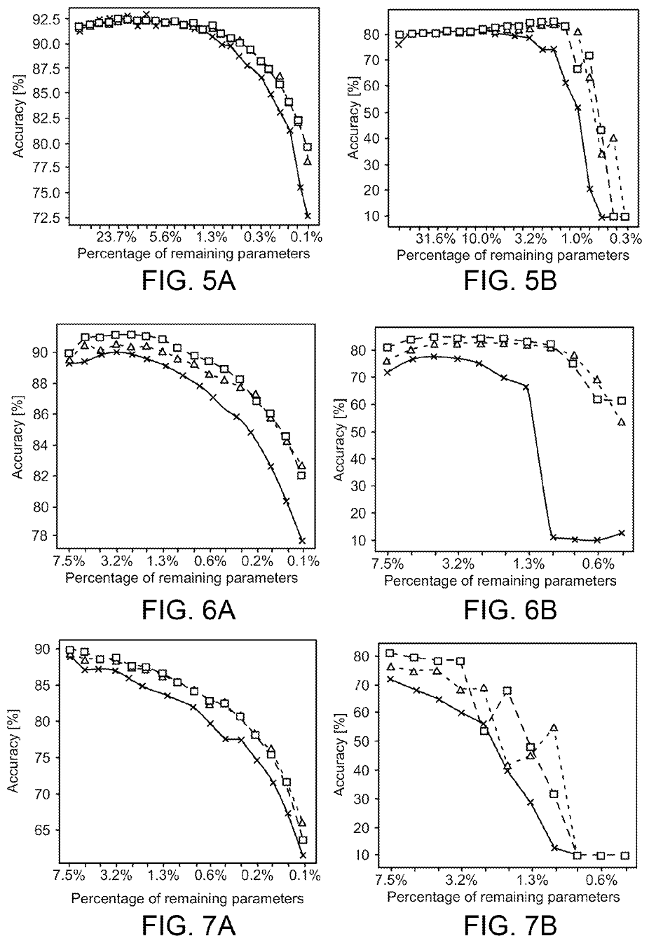

FIGS. 5A to 7B show plots of different performance metrics for different parameter pruning methods. FIGS. 5A to 7B each show a plot of an accuracy of the different parameter pruning methods in dependence on a percentage of a number of remaining parameters of the pruned model. Experimental data obtained using the pruning method disclosed herein is represented in FIGS. 5A to 7B by the squares.

Experimental data obtained using a pruning method as described in “Scalable training of artificial neural networks with adaptive sparse connectivity inspired by network science” by Decebal Constantin Mocanu, Elena Mocanu, Peter Stone, Phuong Nguyen, Madeleine Gibescu, Antonio Liotta, Nature Communications volume 9, Article number: 2383 (2018), is represented by the crosses in FIGS. 5A to 7B. This method will also be referred to ERK. This method does not require any training of parameters prior to pruning.

Experimental data obtained using a pruning method as described in “Layer-adaptive sparsity for the Magnitude-based Pruning” by Lee, J., Park, S., Mo, S., Ahn, S., Shin, J. (2020), arXiv: 2010.07611, is represented by the triangles in FIGS. 5A to 7B. This method will also be referred to as LAMP. In this method, an initially trained model is gradually pruned by alternating between training and gradual removal of more parameters. This method may be considered as an iterative pruning method.

Both the ERK and the LAMP methods can be considered as magnitude based pruning methods. In these methods, a number of parameters to be removed or maintained is solely decided based on a magnitude of each parameter. For example, a number of parameters having the lowest magnitude may be set to zero and not trained.

The pruning methods were applied to a convolution neural network model for image recognition, namely VGG-16, using the CIFAR-10 dataset. FIGS. 5A, 6A and 7A show the plots of the performance metrics for the different pruning methods applied to the VGG-16 model. The pruning methods were also applied to another convolutional neutral network, namely EfficientNet-B0, using the CIFAR-10 dataset. FIGS. 5B, 6B and 7B show the plots of the performance metrics for the different pruning methods applied to the EfficientNet-B0 model.

The experimental data shown in FIGS. 5A and 5B was acquired by first training the different models to achieve a high accuracy. Subsequently, the number of parameters of each model were iteratively reduced, as described in “Layer-adaptive sparsity for the Magnitude-based Pruning” by Lee, J., Park, S., Mo, S., Ahn, S., Shin, J. (2020), arXiv: 2010.07611. From FIGS. 5A and 5B, it can be seen that for the pruning method disclosed herein higher accuracies were determined than the ERK pruning method. The accuracies determined for the pruning method disclosed herein are comparable to those of the LAMP pruning method.

The experimental data shown in FIGS. 6A and 6B was acquired by randomly removing 90% of the parameters of each model in the first iteration after initialisation. The parameters to be removed were selected based on a respective magnitude of each parameter. The magnitude of each parameter may also be referred to as the L1 measure. In this example, the parameters with the lowest magnitude were removed. Subsequently to pruning, each of the models were iteratively trained as described in “Layer-adaptive sparsity for the Magnitude-based Pruning” by Lee, J., Park, S., Mo, S., Ahn, S., Shin, J. (2020), arXiv: 2010.07611. As described above in relation to FIGS. 5A and 5B, the number of parameters of each model were iteratively reduced. This scenario can be considered equivalent to initially setting a global pruning level of 90% in the first iteration, followed by increasingly constraining the bandwidth of the communication link between the server and worker. It can be seen from FIGS. 6A and 6B that the accuracies determined for the pruning method disclosed herein are higher than the accuracies determined for both the ERK and LAMP methods.

The experimental data shown in FIGS. 7A and 7B was acquired by randomly initialising the parameters of the models and resetting the parameters after every training iteration, which may also be considered equivalent to “pruning at initialisation”. This was repeated for different levels of reduction of the parameters, e.g. different pruning levels. It can be seen from FIGS. 7A and 7B that the accuracies determined for the pruning method disclosed herein are higher than the accuracies determined for both the ERK and LAMP methods.

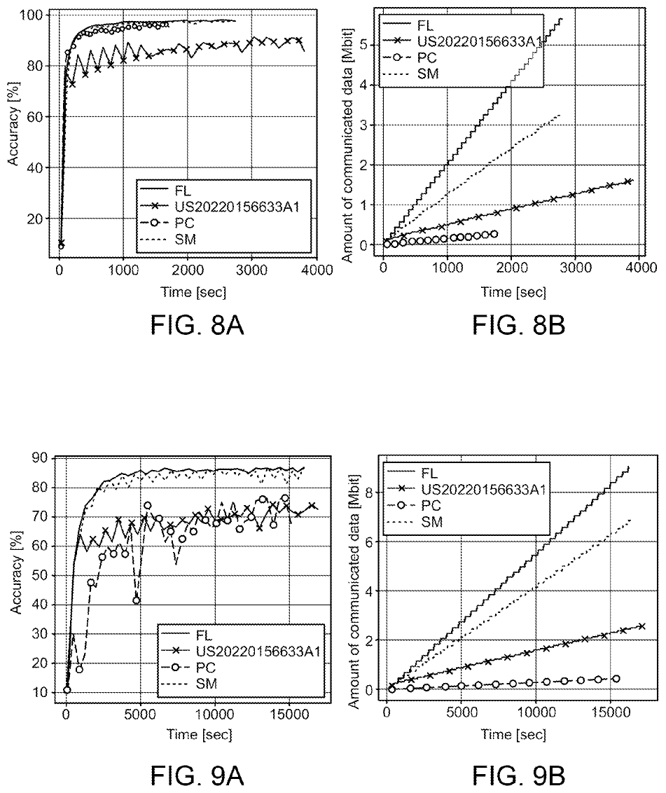

FIGS. 8A to 9B show plots of different performance metrics for different federated machine learning methods. FIGS. 8A and 9A each show a plot of an accuracy determined for each of the methods over time. FIGS. 8B and 9B each show a plot of an amount of data communicated through the entire network as recorded by the parameter server over time.

Experimental data obtained using a federated machine learning method without any compression is represented by the solid line and labelled “FL” in FIGS. 8A to 9B. Experimental data obtained using the federated machine learning method described in US 2022/0156633 A1, which is hereby incorporated in its entirety by reference, is represented by the crosses and labelled “US20220156633A1” in FIGS. 8A to 9B. Experimental data obtained using the method disclosed herein is represented by the circles and labelled “PC” in FIGS. 8A to 9B. Experimental data obtained using the method described in “Dynamic Sampling and Selective Masking for Communication-Efficient Federated Learning” by Shaoxiong Ji, Wenqi Jiang, Anwar Walid and Xue Li, (2021), arXiv: 2003.09603, is represented by the dashed line and labelled “SM” in FIGS. 8A to 9B.

The experimental data shown in FIGS. 8A and 8B was obtained by using the MNIST (Modified National Institute of Standards and Technology) dataset. From FIG. 8A, it can be seen that the accuracies determined for the different methods is comparable. However, for the method described in in US 2022/0156633 A1 lower accuracies were determined. The amount of communicated data determined for the method described herein is less than the amount of communicated data determined for any of the other methods mentioned above, as shown in FIG. 8B.

The experimental data shown in FIGS. 9A and 9B was obtained using the CIFAR-10 dataset. From this figure, it can be seen that the accuracy determined for the method described herein is comparable with the accuracy determined for the method described in US 2022/0156633 A1. The amount of communicated data determined for the method described herein is less than the amount of communicated data determined for any of the other methods mentioned above, as shown in FIG. 9B.

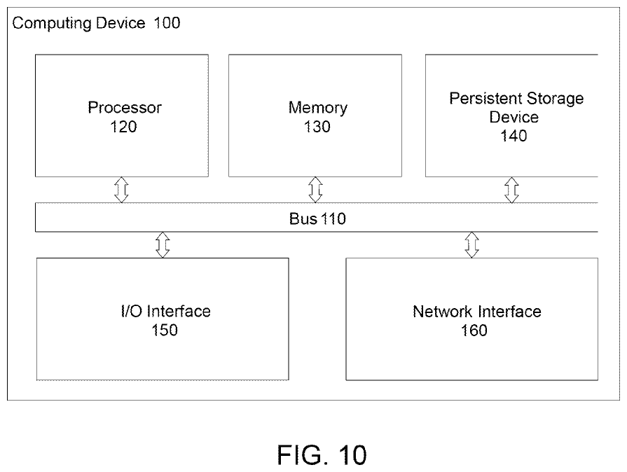

FIG. 10 shows a computing device 100 for putting the methods described herein into practice. The computing device 100 may be the server 10 or one of the workers 20.

The computing device 100 includes a bus 110, a processor 120, a memory 130, a persistent storage device 140, an Input/Output (I/O) interface 110, and a network interface 160.

The bus 110 interconnects the components of the computing device 100. The bus may be any circuitry suitable for interconnecting the components of the computing device 100. For example, where the computing device 100 is a desktop or laptop computer, the bus 110 may be an internal bus located on a computer motherboard of the computing device. As another example, where the computing device 100 is a smartphone or tablet, the bus 110 may be a global bus of a system on a chip (SoC).

The processor 120 is a processing device configured to perform computer-executable instructions loaded from the memory 130. Prior to and/or during the performance of computer-executable instructions, the processor may load computer-executable instructions over the bus from the memory 130 into one or more caches and/or one or more registers of the processor. The processor 120 may be a central processing unit with a suitable computer architecture, e.g. an x86-64 or ARM architecture. The processor 120 may include or alternatively be specialized hardware adapted for application-specific operations.

The memory 130 is configured to store instructions and data for utilization by the processor 120. The memory 130 may be a non-transitory volatile memory device, such as a random access memory (RAM) device. In response to one or more operations by the processor, instructions and/or data may be loaded into the memory 130 from the persistent storage device 140 over the bus, in preparation for one or more operations by the processor utilising these instructions and/or data.

The persistent storage device 140 is a non-transitory non-volatile storage device, such as a flash memory, a solid state disk (SSD), or a hard disk drive (HDD). A non-volatile storage device maintains data stored on the storage device after power has been lost. The persistent storage device 140 may have a significantly greater access latency and lower bandwidth than the memory 130, e.g. it may take significantly longer to read and write data to/from the persistent storage device 140 than to/from the memory 130. However, the persistent storage 140 may have a significantly greater storage capacity than the memory 130.

The I/O interface 150 facilitates connections between the computing device and external peripherals. The I/O interface 150 may receive signals from a given external peripheral, e.g. a keyboard or mouse, convert them into a format intelligible by the processor 120 and relay them onto the bus for processing by the processor 120. The I/O interface 150 may also receive signals from the processor 120 and/or data from the memory 130, convert them into a format intelligible by a given external peripheral, e.g. a printer or display, and relay them to the given external peripheral.

The network interface 160 facilitates connections between the computing device and one or more other computing devices over a network. For example, the network interface 160 may be an Ethernet network interface, a Wi-Fi network interface, or a cellular network interface.

Implementations of the subject matter and the operations described in this specification can be realized in digital electronic circuitry, or in computer software, firmware, or hardware, including the structures disclosed in this specification and their structural equivalents, or in combinations of one or more of them. For instance, hardware may include processors, microprocessors, electronic circuitry, electronic components, integrated circuits, etc. Implementations of the subject matter described in this specification can be realized using one or more computer programs, i.e., one or more modules of computer program instructions, encoded on computer storage medium for execution by, or to control the operation of, a data processing apparatus. Alternatively or in addition, the program instructions can be encoded on an artificially-generated propagated signal, e.g., a machine-generated electrical, optical, or electromagnetic signal that is generated to encode information for transmission to suitable receiver apparatus for execution by a data processing apparatus. A computer storage medium can be, or be included in, a computer-readable storage device, a computer-readable storage substrate, a random or serial access memory array or device, or a combination of one or more of them. Moreover, while a computer storage medium is not a propagated signal, a computer storage medium can be a source or destination of computer program instructions encoded in an artificially-generated propagated signal. The computer storage medium can also be, or be included in, one or more separate physical components or media (e.g., multiple CDs, disks, or other storage devices).

While certain arrangements have been described, the arrangements have been presented by way of example only, and are not intended to limit the scope of protection. The inventive concepts described herein may be implemented in a variety of other forms. In addition, various omissions, substitutions and changes to the specific implementations described herein may be made without departing from the scope of protection defined in the following claims.

1. A computer-implemented method for training a machine learning model in a distributed system, the distributed system comprising a plurality of nodes that exchange updates to communally train the machine learning model, each node of the plurality of nodes maintaining a local version of the machine learning model, the local version of the machine learning model of each of the plurality of nodes having been initialised with the same one or more respective parameter values, the method comprising a node:
receiving an update to a local model from at least one other node in the distributed system, the local model comprising the local version of the machine learning model and the update comprising a dense array of one or more first parameter deltas, the one or more first parameter deltas being ordered in the dense array in an order determined by a reference model, each first parameter delta representing a difference between a parameter of the local model and a corresponding parameter of an updated version of the machine learning model that is maintained by the at least other node;
updating the local model based on the received update and the reference model to determine an updated local model;
determining one or more second parameter deltas, each second parameter delta representing a difference between a parameter of the updated local model and a corresponding parameter of a previous version of the local model; and
sending an update to the at least one other node in the distributed system, wherein the update comprises a dense array of the one or more second parameter deltas, the one or more second parameter deltas being ordered in the dense array in an order determined by the reference model.

2. The method of claim 1, wherein:
the one or more first parameter deltas are ordered in the dense array according to a magnitude of one or more corresponding parameters of the reference model; and
the one or more second parameter deltas are ordered in the dense array according to a magnitude of one or more corresponding parameters of the reference model.

3. The method of claim 1, wherein the plurality of nodes comprises a plurality of workers and a server, wherein:
each of the plurality of workers is configured to train a respective local model and report updates to the local model back to the server; and
the server is configured to aggregate updates from the workers to update a global model and report updates to the global model back to the workers, the server being configured to aggregate the updates from the workers based on the reference model.

4. The method of claim 3, wherein the reference model comprises a copy of a version of the global model that precedes the updated version of the global model.

5. The method of claim 3, wherein the node is a worker and the method comprises:
receiving the update to the local model from the server, the one or more first parameter deltas being indicative of a current state of every updated parameter of the global model; and
wherein updating the local model comprises applying the update to the local model to bring the local model into compliance with the global model.

6. The method of claim 3, wherein the node is a worker and the method comprises:
determining a level of reduction of a number of parameters of the local model;
applying the determined level of reduction of the number of parameters to the local model to produce a reduced local model;
applying the determined level of reduction of the number of parameters of the local model to the reference model;
training the reduced local model based on training data to obtain the updated local model; and
sending the update to the server for use in updating the global model.

7. The method of claim 6, wherein determining the level of reduction of the number of parameters of the local model comprises:
determining a quality of service of a communication link between the worker and the server; and
determining the level of reduction of the number of parameters of the local model based on the quality of service.

8. The method of claim 7 comprising adjusting the level of reduction of the number of parameters of the local model based on the quality of service.

9. The method of claim 8, wherein adjusting the level of reduction of the number of parameters of the local model based on the quality of service comprises:
decreasing the level of reduction of the number of parameters of the local model in response to an increase of the quality of service; and
increasing the level of reduction of the number of parameters of the local model in response to a decrease of the quality of service.

10. The method of claim 9, wherein when the level of reduction of the number of parameters of the local model is decreased, applying the determined level of reduction of the number of parameters to the local model comprises:
including one or more additional parameters in the local model, the one or more additional parameters to be included in the local model being determined based on the reference model.

11. The method of claim 6, wherein the local model comprises a plurality of layers and wherein applying the determined level of the reduction of the number of parameters to the local model comprises:
distributing the reduced number of parameters across the plurality of layers of the local model such that each of the plurality of layers of the local model comprises a same number of parameters.

12. The method of claim 11, wherein when at least one layer of the plurality of layers of the local model is full, applying the determined level of the reduction of the number of parameters to the local model further comprises:
excluding the at least one layer from a further distribution of the reduced number of parameters; and
distributing the reduced number of parameters across one or more remaining layers of the plurality of layers of the local model such that each of the one or more remaining layers of the plurality of layers of the local model comprises a same number of parameters.

13. The method of claim 6, wherein the reference model comprises a plurality of layers and wherein applying the determined level of the reduction of the number of parameters to the reference model comprises:
distributing the reduced number of parameters across the plurality of layers of the reference model such that each of the plurality of layers of the reference model comprises a same number of parameters, one or more parameters of each of the plurality of layers of the reference model corresponding to one or more parameters of each of the plurality of layers of the local model.

14. The method of claim 13, wherein when at least one layer of the plurality of layers of the reference model is full, applying the determined level of the reduction of the number of parameters to the reference model further comprises:
excluding the at least one layer from a further distribution of the reduced number of parameters; and
distributing the reduced number of parameters across one or more remaining layers of the plurality of layers of the reference model such that each of the one or more remaining layers of the plurality of layers of the reference model comprises a same number of parameters.

15. The method of claim 7 further comprising:
sending by the worker a full update of the local model representing the current state of every parameter of the local model, when the quality of service exceeds an upper threshold; or
omitting sending of the update by worker, when the quality of service is below a lower threshold.

16. The method of claim 3, wherein the node is the server and the local model maintained by the node is the global model that is locally maintained by the server and wherein:
receiving an update to a local model comprises receiving a plurality of updates from the plurality of workers, each update comprising a dense array of one or more second parameter deltas;
updating the local model comprises aggregating the updates from the plurality of workers to update the global model based on the reference model; and
the update is sent by the server to each of the workers for use in updating their respective local models.

17. The method of claim 16, wherein the one or more second parameter deltas are indicative of the current state of every updated parameter of the global model.

18. The method of claim 1, wherein the local version of the machine learning model of each of the plurality of nodes are randomly initialised with the same one or more respective parameter values.

19. A node for use in a distributed system comprising a plurality of nodes that exchange updates to communally train a machine learning model, each node of the plurality of nodes maintaining a local version of the machine learning model, the local version of the machine learning model of each of the plurality of nodes having been initialised with the same one or more respective parameter values, the node comprising:
storage configured to store a local model comprising the local version of the machine learning model; and
a processor configured to:
receive an update to a local model from at least one other node in the distributed system, the update comprising a dense array of one or more first parameter deltas, the one or more first parameter deltas being ordered in the dense array in an order determined by a reference model, each first parameter delta representing a difference between a parameter of the local model and a corresponding parameter of an updated version of the machine learning model that is maintained by the at least other node;
update the local model based on the received update and the reference model to determine an updated local model;
determine one or more second parameter deltas, each second parameter delta representing a difference between a parameter of the updated local model and a corresponding parameter of a previous version of the local model; and
send an update to the at least one other node in the distributed system, wherein the update comprises a dense array of the one or more second parameter deltas, the one or more second parameter deltas being ordered in the dense array in an order determined by the reference model.

20. A non-transitory computer-readable medium comprising computer executable instructions that, when executed by a computer, configure the computer to act as a node within a distributed system, the distributed system comprising a plurality of nodes that exchange updates to communally train a machine learning model, each node of the plurality of nodes maintaining a local version of the machine learning model, the local version of the machine learning model of each of the plurality of nodes having been initialised with the same one or more respective parameter values, the computer executable instructions causing the computer to:
receive an update to a local model from at least one other node in the distributed system, the local model comprising the local version of the machine learning model and the update comprising a dense array of one or more first parameter deltas, the one or more first parameter deltas being ordered in the dense array in an order determined by a reference model, each first parameter delta representing a difference between a parameter of the local model and a corresponding parameter of an updated version of the machine learning model that is maintained by the at least other node;
update the local model based on the received update and the reference model to determine an updated local model;
determine one or more second parameter deltas, each second parameter delta representing a difference between a parameter of the updated local model and a corresponding parameter of a previous version of the local model; and
send an update to the at least one other node in the distributed system, wherein the update comprises a dense array of the one or more second parameters, the one or more second parameters being ordered in the dense array in an order determined by the reference model.
